(19) United States
(12) Patent Application Publication
(10) Pub. No.: US 2023/0406450 A1
(43) Pub. Date: Dec. 21, 2023

(54) TEMPERATURE-CONTROLLED STORAGE FOR A VEHICLE

(71) Applicant: Polaris Industries Inc., Medina, MN (US)

(72) Inventors: Matthew J. Prusak, Salol, MN (US); Derek R. Thibert, Roseau, MN (US); Trevor F. Rhodes, Badger, MN (US); Cory A. Wimpfheimer, Greenbush, MN (US); Swanand Umesh Bhargav, Thane (IN)

(73) Assignee: Polaris Industries Inc., Medina, MN (US)

(21) Appl. No.: 18/211,705

(22) Filed: Jun. 20, 2023

Related U.S. Application Data
(60) Provisional application No. 63/353,883, filed on Jun. 21, 2022.

(51) Int. Cl. B62M 27/02; B62J 9/10; B62J 50/22

(52) U.S. Cl. CPC B62M 27/02; B62J 9/10; B62J 50/22; B62M 2027/028

(57) ABSTRACT

A temperature-controlled storage compartment includes a bottom panel, a plurality of side panels extending vertically upward from the bottom panel and defines an interior region of the temperature-controlled storage compartment, and a lid movably coupled with the plurality of side panels such that the temperature-controlled storage compartment may be fully enclosed. The temperature-controlled storage compartment further includes at least one temperature unit arranged within the temperature-controlled storage compartment and a power feature configured for at least partial positioning within the temperature-controlled storage compartment.

### CROSS REFERENCE TO RELATED APPLICATIONS

The present disclosure claims the benefit of U.S. Provisional Application Ser. No. 63/353,883, filed on Jun. 21, 2022, the entire disclosure of which being expressly incorporated herein in its entirety for all purposes.

### FIELD OF THE DISCLOSURE

The present disclosure relates to storage for vehicles, and more specifically, temperature-controlled storage for vehicles.

### BACKGROUND

Generally, snowmobiles are available for various applications such as deep snow, high performance, luxury touring, and trail riding, for example. These applications may require that the riders be able to store and/or tow objects for use such as tools, food, or various other accessories and items. There remains a need for increased storage within snowmobiles for storing and towing desired objections.

### SUMMARY OF THE DISCLOSURE

In an exemplary embodiment of the present disclosure, a temperature-controlled storage compartment for a vehicle is provided. The temperature-controlled storage compartment includes a bottom panel, a plurality of side panels extending vertically upward from the bottom panel and defines an interior region of the temperature-controlled storage compartment, and a lid movably coupled with the plurality of side panels such that the temperature-controlled storage compartment may be fully enclosed. The temperature-controlled storage compartment further includes at least one temperature unit arranged within the temperature-controlled storage compartment and a power feature configured for at least partial positioning within the temperature-controlled storage compartment.

In another exemplary embodiment of the present disclosure, a snowmobile with a temperature-controlled storage area is provided. The vehicle includes a plurality of ground engaging members, a powertrain operatively coupled to the ground engaging members to power movement of the ground engaging members, a structural frame support by the plurality of ground engaging members, the structural frame including a tunnel and a front portion positioned forward of the tunnel, and a steering assembly supported by the structural frame and operatively coupled to the ground engaging members. The vehicle further includes a display positioned generally adjacent the steering assembly, and wherein the temperature-controlled storage area is operably coupled to at least one of an input on the steering assembly and an input on the display and the at least one input is configured for adjusting a temperature level of the temperature-controlled storage area.

In another exemplary embodiment of the present disclosure, a storage compartment for a vehicle is provided. The storage compartment includes a bottom panel, a plurality of side panels extending vertically upward from the bottom panel and defining an interior region of the storage compartment, a lid movably coupled with the plurality of side panels such that the storage compartment may be fully enclosed, at least one temperature unit arranged within the storage compartment for providing one of heating and cooling to the storage compartment, and a power feature configured for at least partial positioning within the storage compartment.

Additional features and advantages of the present disclosure will become apparent to those skilled in the art upon consideration of the following detailed description of the illustrative embodiments.

### BRIEF DESCRIPTION OF THE DRAWINGS

The foregoing aspects and many of the intended advantages of the invention(s) disclosed herein will become more readily appreciated as the same becomes better understood by reference to the following detailed description when taken in conjunction with the accompanying drawings.

FIG. 1 illustrates a top view of an exemplary snowmobile with a storage compartment;

FIG. 2 illustrates a front view of the exemplary snowmobile of FIG. 1;

FIG. 3 illustrates an enlarged view of a storage compartment for use with the snowmobile of FIG. 1;

FIG. 4 illustrates a schematic of the storage compartment and a control system for the use with the storage compartment;

FIG. 5 illustrates an additional schematic of the controller for use with the storage compartment;

FIG. 6 illustrates a front view of an additional embodiment of a storage compartment;

FIG. 7 illustrates a top view of an interior region of an embodiment of a storage compartment with a power feature; and

FIG. 8 illustrates a rear top view of a portion of the storage compartment of FIG. 7.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. For example, while the following description refers primarily to a snowmobile, it should be understood that the principles of the invention apply equally to other snow vehicles. While the disclosure relates to snowmobiles, it is contemplated that the present disclosure is applicable to any tracked vehicle or vehicle that includes a track and, as such, the invention(s) of the present application are not to be limited to snowmobiles.

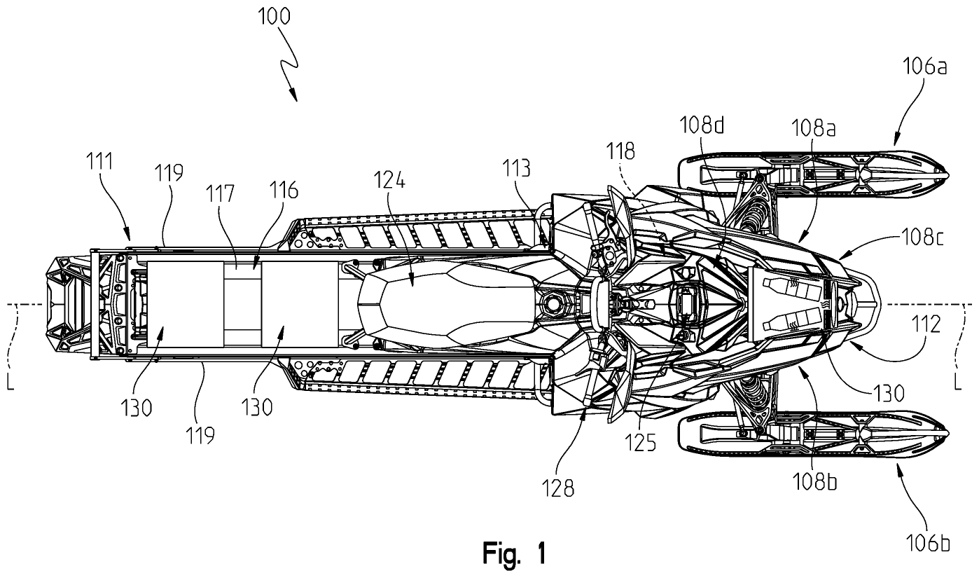

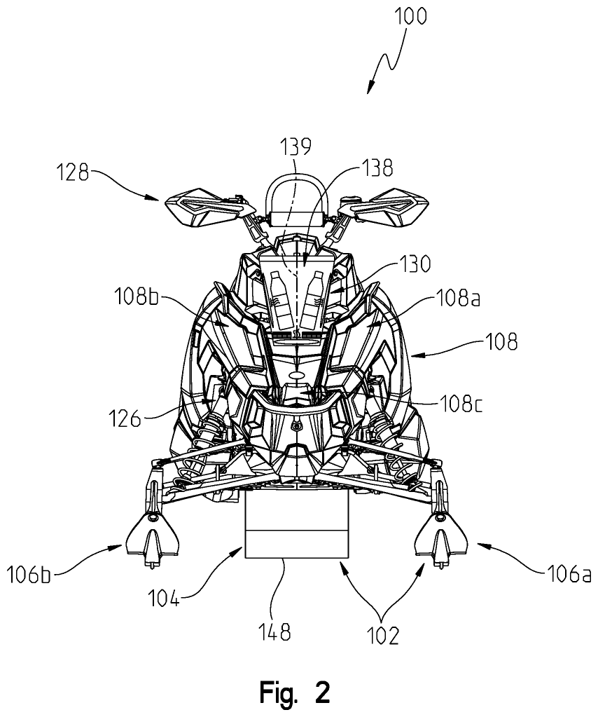

Referring to FIGS. 1-2, an illustrative embodiment of a vehicle, illustratively a snowmobile 100, is shown. While the vehicle is described herein as a snowmobile, various other vehicles may be used in combination with the embodiments of the present disclosure, including but not limited to, off-road vehicles, utility vehicles, and on-road vehicles. Snowmobile 100 includes a plurality of body panels 108. Specifically, snowmobile 100 comprises a left-side panel 108a, a right-side panel 108b, and a front panel 108c. Front panel 108c may also be referred to as a hood. Snowmobile 100 may additionally include a top body panel 108d positioned forward of various instruments of the snowmobile 100. For example, top body panel 108d may be positioned generally adjacent steering assembly structures, such as handlebars or a steering wheel, and may support or be positioned forward of an operator interface, a gauge, a display, and/or various other appliable instruments. Snowmobile 100 additionally includes a plurality of ground engaging members 102. Illustratively, ground engaging members 102 include an endless track assembly 104 including endless track belt 148 and at least one front ski 106, for example a front left ski 106a and a front right ski 106b. Endless track assembly 104 supports a rear portion of snowmobile 100 while skis 106 support a front portion of snowmobile 100. Further, endless track assembly 104 is operatively coupled to a powertrain assembly (not shown), for example an electric powertrain assembly.

With reference still to FIGS. 1 and 2, snowmobile 100 includes a structural frame 110 extending along a longitudinal axis L. Structural frame 110 includes a front frame portion 112 which is generally supported by skis 106. Structural frame 110 further includes a tunnel 116 which is generally supported by endless track assembly 104. Tunnel 116 extends from a rear longitudinal end 111 to a front longitudinal end 113 and is defined by an upper surface 117 and at least two upstanding panels 119. Additionally, front frame portion 112 of structural frame 110 may include an overstructure 118 which supports a steering assembly 128 of snowmobile 100. As illustrated, steering assembly 128 may be include a plurality of handlebars for manipulation by the operator. Overstructure 118 additionally supports an operator interface or a display 125. Structural frame 110 further supports an operator seat 124, which may also be referred to as a straddle seat. However, various other types of seating may be incorporated.

The above-described configuration of snowmobile 100, specifically tunnel 116 and front portion 112 of structural frame 110 may include a space for storage for snowmobile 100. Storage areas may be implemented into snowmobile 100 that may be used for carrying various items such as tools, food, electronics, and other desired items. As will be described further herein, the storage area may be temperature controlled by the operator and may have mechanisms for providing power.

FIG. 1 illustrates an embodiment for a storage area or a storage compartment 130 in several possible locations on snowmobile 100. More specifically, storage compartment 130 is illustrated in a first position at a rear portion of tunnel 116, proximate rear longitudinal extent 111 of tunnel 116. Storage compartment 130 is illustrated in a second position arranged adjacent operator seat 132. Storage compartment 130 may alternatively be positioned at any longitudinal position of tunnel 116, such as forward of seat 132. Further, an additional arrangement of storage compartment 130 is illustrated where storage compartment 130 is positioned longitudinally forward of steering assembly 128 and longitudinally rearward of a forwardmost point of snowmobile 100, for example longitudinally rearward of headlights of snowmobile 100. In this configuration, and as best illustrated in FIG. 2, storage compartment 130 is positioned vertically above a bulkhead 126 of snowmobile 100. Bulkhead 126 may be generally defined by overstructure 118 and may comprise the engine compartment of snowmobile 100. In some embodiments, there may be a divider positioned between the engine compartment and storage compartment 130 such that the storage compartment 130 is physically separated from the engine components. While snowmobile 100 is described herein as having one storage compartment 130, in some embodiments, a plurality of storage compartments 130 may be incorporated. For example, snowmobile 100 may include two or more storage compartments 130 arranged within snowmobile 100 in any of the above-described positions.

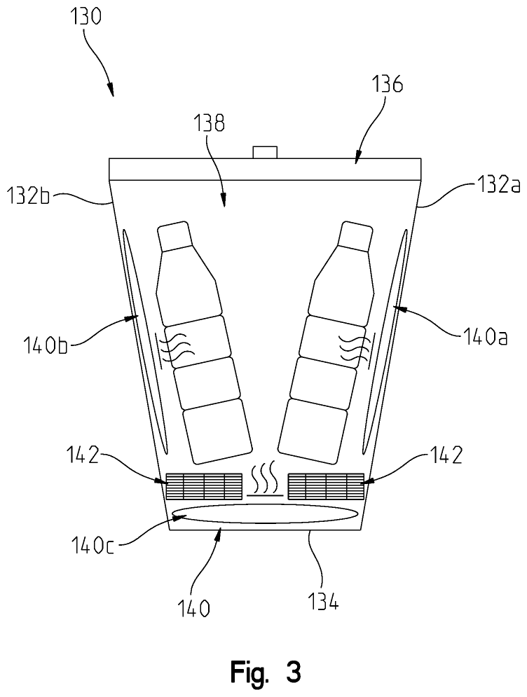

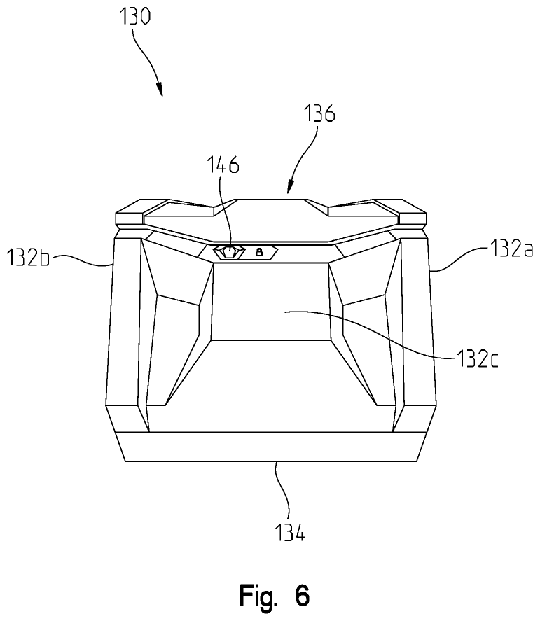

Storage compartment 130 may be a bag, a box, or an otherwise enclosable volume. In the illustrative embodiments of FIGS. 1 and 2, storage compartment 130 has a rectangular configuration. As shown in FIG. 3, storage compartment 130 is defined by a bottom panel 134, a plurality of side panels 132, illustratively a first side panel 132a and a second side panel 132b, and a top panel 136. The plurality of side panels 132 additionally include a third side panel 132c and a fourth side panel 132d shown in the embodiment of storage compartment 130 in FIGS. 6-8. Top panel 136 is configured to be supported on at least one of the plurality of side panels 132 and is configured to move between a closed position concealing an interior region or volume 138 of storage compartment 130 and an open position to expose interior region 138. When top panel 136 is engaged with the plurality of side panels 132, top panel 136 may provide a fluid-tight seal between interior region 138 of storage compartment 130 and the external environment around storage compartment 130. In this way, there may be liquid stored in storage compartment 130 without risking leakage into snowmobile 100 and subsequent contamination of internal or external components of snowmobile 100. In various embodiments, storage compartment 130 is positioned rearward of top body panel 108d such that top panel 136 of storage compartment 130 may be accessed and opened without requiring the opening of or removal of top body panel 108d. In other embodiments, storage compartment 130 may be positioned such that top panel 136 is flush with top body panel 108d of snowmobile 100 and/or may extend slightly out of top body panel 108d. In further embodiments, a portion of top body panel 108d may define top panel 136.

While illustrated generally as having one continuous interior region 138, storage compartment 130 may be configured such that interior region 138 comprises several discrete compartments. In this way, different accessories may be arranged in different compartments and stored separately from one another. For example, as illustrated in FIG. 2, at least one dividing feature 139 may separate interior region 138 into two or more separate regions. In further embodiments, interior region 138 may include shelves for further compartmentalizing of storage compartment 130 and increasing storage space available. This may additionally provide for vibration isolation of the accessories within storage compartment 130 during operation of snowmobile 100. Additionally, as previously mentioned, storage compartment 130 may be a temperature-controlled storage compartment 130. The mechanisms of which will be described further herein with reference to FIGS. 3-5.

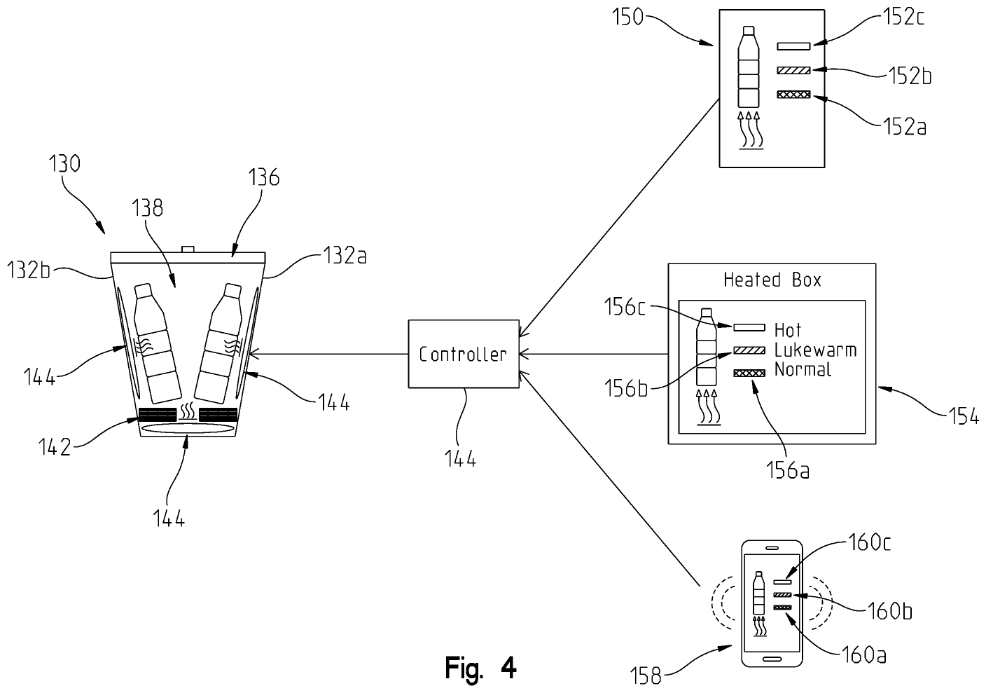

With reference first to FIGS. 3-4, storage compartment 130 is illustrated with first side panel 132a opposite second side panel 132b, bottom panel 134 extending between first side panel 132a and second side panel 132b, and top panel 136 engaged with first side panel 132a and second side panel 132b. Further, storage compartment 130 includes at least one temperature unit 140. Specifically, in the illustrative embodiment of FIGS. 3-4, storage compartment 130 includes a first temperature unit 140a, a second temperature unit 140b, and a third temperature unit 140c. First and second temperature units 140a, 140b are positioned adjacent first and second side panels 132a, 132b. In some embodiments, first and second temperature units 140a, 140b are adhered to, embedded within, or otherwise coupled with first and second side panels 132a, 132b. In other embodiments, first and second temperature units 140a, 140b may be spaced apart from first and second side panels 132a, 132b. Third temperature unit 140c is positioned adjacent bottom panel 134. Similar to first temperature unit 140a and second temperature unit 140b, third temperature unit 140c may be adhered to, embedded within, or otherwise coupled to bottom panel 134. In embodiments, there may be a heat spreader 142 positioned adjacent any of temperature units 140. As illustrated, heat spreader 142 is positioned vertically above third temperature unit 140c such that third temperature unit 140c is positioned intermediate between heat spreader 142 and bottom panel 134. The configuration of heat spreader 142 distributes the heat emitted from third temperature unit 140c (or temperature units 140a, 140b) to ensure that heat is spread evenly throughout storage compartment 130. Heat spreader 142 may be a plate of metal, for example at least one plate of copper. However, various other applicable heat spreaders may be used.

In some embodiments, each of temperature units 140 may be a thin film heater, a heating pad, a silicone heater, and/or a laser direct structure. In these embodiments, the laser direct structure may be embedded within bottom panel 136 or within at least one of the plurality of side panels 132. Additionally, while temperature unit(s) 140 has been described herein as a heating unit, temperature unit(s) 140 may also be configured for cooling and/or storage compartment 130 may also incorporate a separate cooling unit and/or cooling mechanism. For example, cooling units may be used to refrigerate storage compartment 130 to ensure that items that need to stay at low temperatures are maintained in a refrigerated atmosphere during operation of snowmobile 100.

Temperature units 140 may be powered by a battery of snowmobile 100 such that temperature units 140 may only be operational during use of snowmobile 100. In other embodiments, storage compartment 130 may include a separate battery or other power source such that it may be operational for a finite amount of time while snowmobile 100 is turned off or otherwise not operational.

The at least one temperature unit 140 of storage compartment 130 may be actuated through several different mechanisms through the use of a control system. For example, as illustrated in the schematic of FIG. 4, a controller 144 may be used to control the operation of temperature units 140 based on the input provided from various different interfaces. In some embodiments, snowmobile 100 may include a hand control button 150 that may be actuated by the user. In some embodiments, hand control button 150 is integrated with steering assembly 128 of snowmobile 100 or with display 125 of snowmobile 100. In embodiments, hand control button 150 is arranged on storage compartment 130. Hand control button 150 may have a plurality of actuators, or buttons, that may be depressed by the operator to control the heating and/or cooling of storage compartment 130. The actuators may also be in the form of a switch, lever, rocker button, or a toggle switch that may be actuated by the operator. For example, hand control button 150 may include a first actuation input 152a that may set the heat at a low level, a second actuation input 152b that may set the heat at a medium level, and a third actuation input 152c that may set the heat at a high level. Further actuation inputs may engage or disengage temperature unit 140.

Each of the actuation inputs 152 may include a visual (i.e., LED) indicator or an auditory indicator to inform the operator which heating level has been selected and/or which level of heat storage compartment 130 is currently at. For example, an LED light associated with first actuation input 152a may emit a green color to indicate that the heat setting is at a low level. An LED light associated with second actuation input 152b may emit an orange color to indicate that the heating setting is at a medium level and/or a lukewarm temperature. Further, an LED light associated with third actuation input 152c may emit a red color to indicate that the heating setting is at a high or hot temperature. However, various other colors or other indicators may be incorporated to identify the heat level that temperature units 140 are set at.

In other embodiments, snowmobile 100 may include a graphical user interface, referred to herein as a human machine interface 154, in communication with controller 144 for controlling the heating and/or cooling levels of storage compartment 130. Human machine interface 154 may be a touchscreen display such that operator may directly interact with human machine interface 154 for controlling heating level. Human machine interface 154 may be a touchscreen integrated with display 125 of snowmobile 100 or may be coupled with any portion of snowmobile 100 or storage compartment 130. Similar to hand control button 150 described previously, human machine interface 154 may include a plurality of actuation inputs 156 for the operator to control the heating and/or cooling of storage compartment 130. As illustrated, human machine interface 154 includes a first actuation input 156a that may set the heat level at a low temperature level, a second actuation input 156b that may set the heat level at a medium temperature level, and a third actuation input 156c that may set the heat level at a high temperature level. However, any number of actuation inputs 156 may be incorporated. Additionally, actuation inputs 156 may each be associated with a visual and/or auditory indicator of the heat level that storage compartment 130 may be at. For example, each actuation input 156 may have an associated alphanumeric listing or phrase to describe the heat level at which the temperature units may be set at or storage compartment 130 may be currently set at.

In further embodiments, instructions may be delivered to controller 144 regarding the temperature setting of storage compartment 130 through a wireless device 158. In some embodiments, wireless device 158 may be a portable electronic device, such as a mobile phone, computer, or tablet. In these embodiments, an application on wireless device 158 may include a plurality of actuation inputs 160 for dictating at which temperature to set storage compartment 130. Further, wireless device 158 may emit visual and/or auditory signals to inform the operator at which temperature storage compartment 130 is set.

In some embodiments, and regardless of the control mechanisms described herein, the “low level” of heat described herein may be defined as having a temperature range between approximately 30-40 degrees Fahrenheit. The “medium level” of heat described herein may be defined as a temperature range between approximately 50 degrees and 65 degrees Fahrenheit. Further, the “high level” of heat described herein may be defined as a temperature range between approximately 70 degrees and 80 degrees Fahrenheit. However, various other ranges may be incorporated, and these ranges may be fully programmable by the operator.

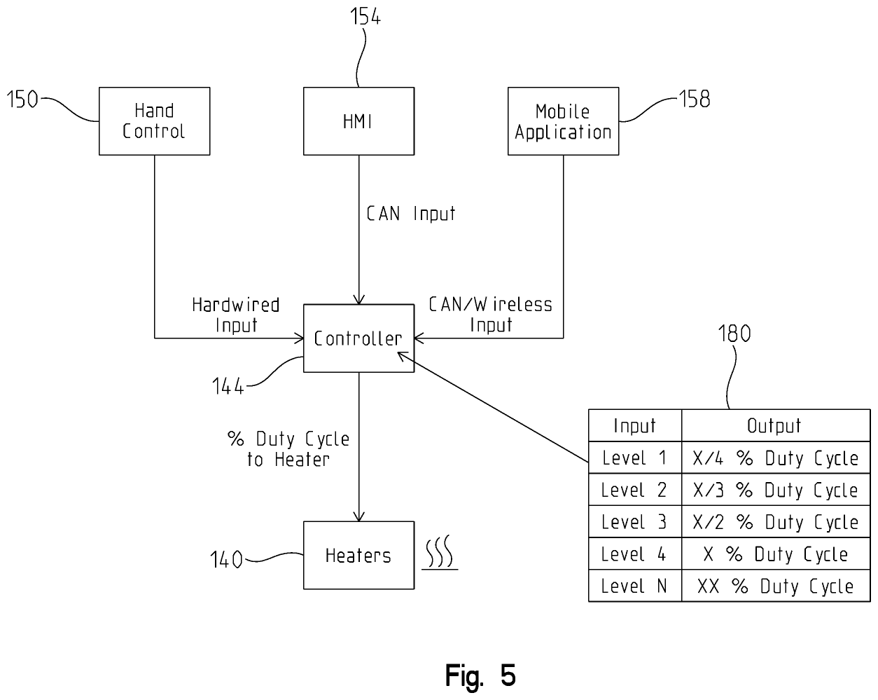

The interaction between the various interfaces and associated actuators/inputs, controller 144, and temperature unit 140 are shown in further detail in the schematic of FIG. 5. As illustrated, input may be provided by the operator through any of the various actuation/input mechanisms described, for example hand control button 150, human machine interface 154, and/or mobile application 158. Inputs from the operator regarding which level of heat is desired is transmitted to controller 144. If an input is provided by hand control 150 through actuation of actuators 152, the input is transmitted through a hardwired input. If input is provided via human machine interface 154 through actuators 156, the input is transmitted through a controller area network (CAN) input. Further, if an input is entered with mobile application 158, the information may be transmitted through a CAN/wireless input to controller 144. After the input regarding which level of temperature control is desired is transmitted to controller 144, controller 144 may use a look up table, for example table 180 shown in FIG. 5, to alter the temperature that is then outputted by temperature units 140. In embodiments, the temperature level is transmitted from the controller 144 to temperature units 140 as a percent duty cycle of temperature units 140. For example, if an operator inputs for the lowest level of heat to be emitted from temperature units 140, controller 144 may refer to table 180 and transmit an output that is a 25% duty cycle, causing a normal temperature to be outputted. The duty cycle may be defined as a ratio of time that the temperature circuit is on compared to the time that the temperature circuit is off. If a medium level, or a level 2, input is selected, this may cause controller 144 to output a 33% duty cycle which would result in lukewarm temperatures being emitted. Further, if a level 3 heat level is selected, this may cause controller 144 to output a 50% duty cycle which would result in warm temperatures being emitted into storage compartment 130. Further, if a level 4 or high heat level is selected, this may cause controller 144 to output a 100% duty cycle which would result in high temperatures being emitted into storage compartment 130. As illustrated, four levels are incorporated in the table, however any number of levels and temperature increments may be incorporated. Further, various other methods of transmission and temperature output may be incorporated with the system and the above embodiment is provided merely as an example. For example, in some embodiments, a toggle, switch, knob and/or button may be incorporated with storage compartment 130. In embodiments, the operator may actuate or adjust the toggle, switch, knob, and/or button between a high and a low temperature. In further embodiments, the operator may adjust the temperature of storage compartment 130 to any discrete degree of temperature that is desired. For example, the knob may be incorporated and may be rotated to indicate a singular temperature value. In these embodiments, the operator may not be restricted to a finite number of heating levels but may instead change the temperature to any desired value.

As a result of the above-described configuration, the operator has full and efficient access to control the temperature of storage compartment 130. This may be particularly advantageous when snowmobile 100 is operated in cold temperatures and items such as electronic accessories, food, beverages, or tools are being carried with snowmobile 100 and require some level of heating. As previously described, temperature control may also be used for cooling storage compartment 130 when cool temperatures for storing items is desired.

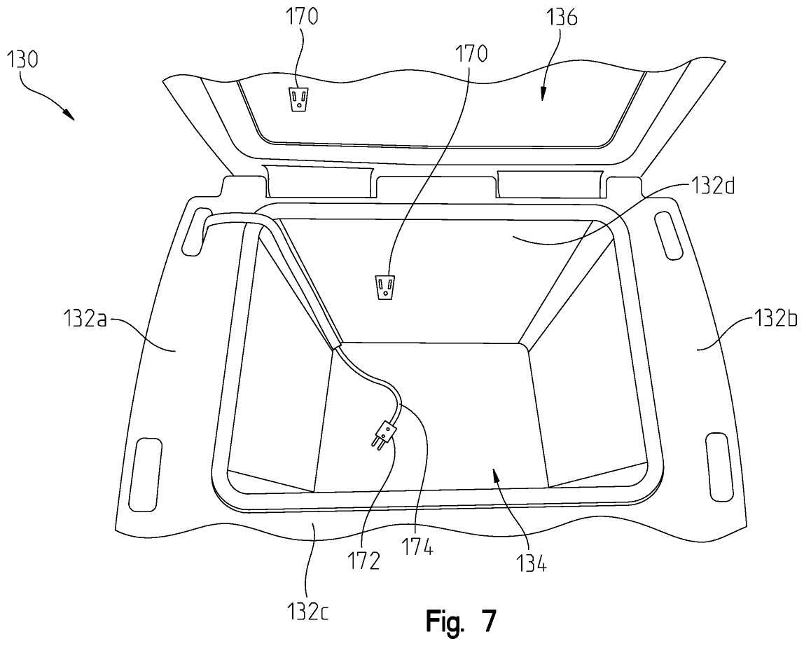

FIG. 6 illustrates a front view of an additional embodiment of storage compartment 130. As illustrated, storage compartment 130 may include a locking toggle 146 to allow for the operator to unlock or lock top panel 136 with side panels 132 to keep storage compartment 130 closed. This unlocking or locking of top panel 136 may be done manually or wirelessly with a mobile device or other application/device. In combination with being temperature-controlled, storage compartment 130 may include a power feature for providing power or charge to various accessories. For example, FIG. 7 illustrates an embodiment of interior region 138 of storage compartment 130 with a power outlet 170 extending out of fourth side panel 132d of storage compartment 130. More specifically, power outlet 170 may extend into an outer surface of fourth side panel 132d and extend through to an inner surface of fourth side panel 132d and may enter interior region 138 of storage compartment 130. However, power outlet 170 may be arranged in various other locations within storage compartment 130. Further, as illustrated, power outlet 170 may additionally or alternatively be positioned within and/or extending out of top panel 136. In these embodiments, top panel 136 and thus power outlet 170 may be easily removed and/or replaced through the removal and/or replacement of top panel 136. This may increase the ease with which maintenance and repairs may be done to power outlet 170. However, various other arrangements of power outlet 170 may be incorporated into storage compartment 130. As noted herein, it may be appreciated that power outlet 170 is fixed within storage compartment 130 and, as such, is not a removeable or accessory power feature. Instead, power outlet 170 is incorporated into storage compartment 130 for permanently available access to power under appropriate battery/power-availability conditions.

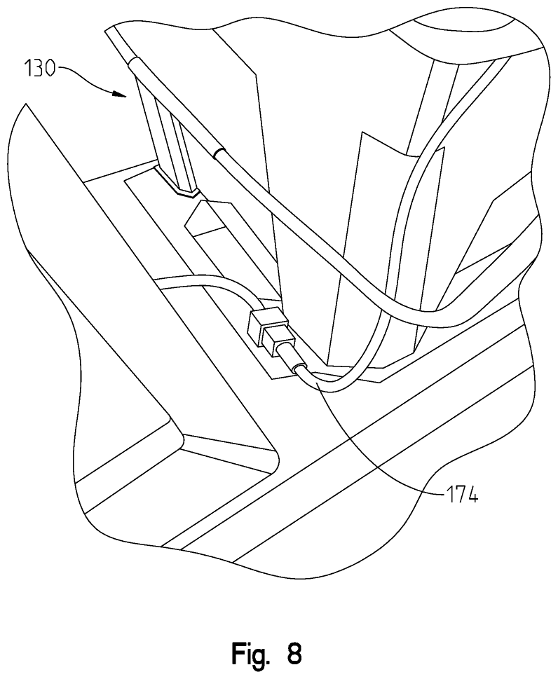

Power outlet 170 may be used to supply power to various accessories and/or tools being carried within storage compartment 130. For example, in some embodiments, it may be desired to charge lithium batteries that may be used with electric tools or various other accessories that are being stored within storage compartment 130. Additionally, it may be desired for handheld devices to be stored and charged within storage compartment 130. The ability to heat storage compartment 130 through the above-described temperature control protects and maintains the viability of batteries and electric accessories within storage compartment 130. The temperature within storage compartment 130 may be monitored during the use of storage compartment 130 as well. As illustrated in FIG. 7, storage compartment 130 includes a temperature sensor, illustratively a thermometer 172, positioned within storage compartment 130 and extending through a junction between bottom panel 134, first side panel 132a and/or fourth side panel 132d. Thermometer 172 may be coupled to a power source through a wire 174 that may extend out of storage compartment 130 and rearwardly of storage compartment 130, as is illustrated in FIG. 8. However, various other methods for monitoring the temperature of storage compartment 130 may be incorporated. In this way, the temperature within storage compartment 130 may be continuously monitored to provide continuous feedback to controller 144 and/or the operator. If the temperature is not at the value and/or level that was inputted by the operator, controller 144 may cause temperature unit 140 to adjust the heating level output to increase and/or decrease the temperature of storage compartment 130 to the desired temperature.

In order to accomplish the power transfer to the batteries or accessories, power outlet 170 includes a wire (not shown) and a coupling member (not shown) for coupling with a power feature or power input portion of a respective accessory or battery stored within storage compartment 130. The wire may extend out of storage compartment 130 to couple with a power source for supplying power to power outlet 170. In some embodiments, power outlet 170 may be supplied by a power source from snowmobile 100, for example a battery of powertrain assembly of snowmobile 100. In these embodiments, storage compartment 130 may only be operational and capable of providing power through power outlet 170 while snowmobile 100 is operating. In other embodiments, storage compartment 130 may have a battery or other power source incorporated within storage compartment 130 to store power that may be used for supplying to power outlet 170, and other accessories. In these embodiments, storage compartment 130 may be capable of providing power for a finite amount of time while snowmobile 100 is powered off and not operational. As a result of both the temperature control and power source elements of storage compartment 130, an operator may safely and securely carry items that must heated, for example those with batteries or electric components, while also providing a charge to these items.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A temperature-controlled storage compartment for a vehicle, comprising:
a bottom panel;
a plurality of side panels extending vertically upward from the bottom panel and defining an interior region of the temperature-controlled storage compartment;
a lid movably coupled with the plurality of side panels such that the temperature-controlled storage compartment may be fully enclosed; and
at least one temperature unit arranged within the temperature-controlled storage compartment.

2. The temperature-controlled storage compartment of claim 1, further comprising a power feature configured for at least partial positioning within the temperature-controlled storage compartment.

3. The temperature-controlled storage compartment of claim 1, wherein the at least one temperature unit comprises a temperature sensor configured for continuous monitoring of a temperature level of the temperature-controlled storage compartment.

4. The temperature-controlled storage compartment of claim 1, wherein the at least one temperature unit comprises one heat unit positioned vertically above the bottom panel and vertically below a heat spreader.

5. The temperature-controlled storage compartment of claim 1, wherein the at least one temperature unit comprises a first temperature unit positioned within the bottom panel and a second temperature unit positioned within at least one of the plurality of side panels.

6. The temperature-controlled storage compartment of claim 1, wherein the at least one temperature unit includes at least one heater unit which is one of a heating pad, a thin film heater, and a laser direct structure.

7. The temperature-controlled storage compartment of claim 2, wherein the power feature is positioned within the interior region such that an accessory arranged within the temperature-controlled storage compartment may be coupled with the power feature.

8. A snowmobile with a temperature-controlled storage area, the vehicle comprising:
a plurality of ground engaging members;
a powertrain operatively coupled to the ground engaging members to power movement of the ground engaging members;
a structural frame supported by the plurality of ground engaging members, the structural frame including a tunnel and a front portion positioned forward of the tunnel;
a steering assembly supported by the structural frame and operatively coupled to the ground engaging members; and
a display positioned generally adjacent the steering assembly;
wherein the temperature-controlled storage area is operably coupled to at least one of an input on the steering assembly and an input on the display and the at least one input is configured for adjusting a temperature level of the temperature-controlled storage area.

9. The snowmobile of claim 8, wherein the temperature-controlled storage area is supported by the front portion of the structural frame.

10. The snowmobile of claim 8, wherein the temperature-controlled storage area is supported by the tunnel of the structural frame.

11. The snowmobile of claim 8, wherein the temperature-controlled storage area includes a power outlet arranged within the temperature-controlled storage area.

12. The snowmobile of claim 8, wherein the display of the snowmobile includes a plurality of actuators for selecting a heat level of the snowmobile.

13. The snowmobile of claim 8, wherein the temperature-controlled storage area is operatively coupled to a mobile device for controlling a heat level of the temperature-controlled storage device.

14. A storage compartment for a vehicle, comprising:
a bottom panel;
a plurality of side panels extending vertically upward from the bottom panel and defining an interior region of the storage compartment;
a lid movably coupled with the plurality of side panels such that the storage compartment may be fully enclosed;
at least one temperature unit arranged within the storage compartment for providing one of heating and cooling to the storage compartment; and
a power feature configured for at least partial positioning within the storage compartment.

15. The storage compartment of claim 14, wherein the at least one temperature unit comprises a temperature sensor configured for continuous monitoring of a temperature level of the storage compartment.

16. The storage compartment of claim 14, wherein the at least one temperature unit comprises one heat unit positioned vertically above the bottom panel and vertically below a heat spreader.

18. The storage compartment of claim 14, wherein the at least one temperature unit comprises a first temperature unit positioned within the bottom panel and a second temperature unit positioned within at least one of the plurality of side panels.

19. The storage compartment of claim 14, wherein the at least one temperature unit includes at least one heater unit which is one of a heating pad, a thin film heater, and a laser direct structure.

20. The storage compartment of claim 14, wherein the power feature is positioned within the interior region such that an accessory arranged within the storage compartment may be coupled with the power feature.
